(19) United States
(12) Patent Application Publication
(10) Pub. No.: US 2005/0208265 A1
(43) Pub. Date: Sep. 22, 2005

(54) Perforated Mat for Supporting Decorative Lights

(76) Inventor: Pierre Desmarais, Cantley, QC (CA)

Correspondence Address: Pierre Desmarais, 376 St-Elizabeth, Cantley, QC, J8V 3G6, CA

(21) Appl. No.: 10/907,103

(22) Filed: Mar. 21, 2005

Related U.S. Application Data
(60) Provisional application No. 60/521,260, filed on Mar. 21, 2004.

(51) Int. Cl. B32B 3/10

(52) U.S. Cl. 428/131

(57) ABSTRACT

A novel perforated mat for supporting decorative lights is disclosed. The perforated mat has a first side and a second side, where a plurality of perforations arranged in a grid pattern traverse the flexible mat from the first side to the second side. At least one of the plurality of perforations is for frictionally supporting an ornamental light therein. Preferably at least some of the perforations are individually addressable for following design template instructions for making of decorative designs using the perforated mat and a string of decorative lights.

This application claims priority from U.S. Provisional Application No. 60/521,260 filed on Mar. 21, 2004.

### FIELD OF THE INVENTION

The invention relates to the field of decorative and ornamental lighting and more specifically to the field of decorative lighting that allows for an improved arrangement of ornamental lights.

### BACKGROUND OF THE INVENTION

Ornamental lighting is used very often to adorn structures during times of celebration, such as holidays. For example, during the Christmas season many people enjoy decorating various structures, such as trees, during this festive season. Unfortunately, not everyone manages to do this decorating in an aesthetically pleasing manner and in some cases would like to make light designs that offer a more aesthetically pleasing pattern than they have managed to attain in the past.

Light Bright™ was a child toy developed sometime ago that allowed for creating of illuminated designs that are displayed on a dark background. The toy uses a lightboard that has a grid of holes in front of a light source that illuminates light pegs pushed through a dark piece of paper placed over the lightboard in order to not allow light to propagate through the dark piece of paper until a hole is created in the paper. These transparent pegs of various colors are stuck through the dark paper in order to allow light from the light source to propagate through the peg and to illuminate it. Children playing with this toy let their imagination roam free in terms of the graphic patterns they created. Optionally, templates were also provided so that the designs would be constrained to the template in order for the design to have a certain aesthetic quality. Of course, not everyone is able to create designs that are aesthetically pleasing. Some people lack creative abilities and as a result their designs lack aesthetics appeal.

Currently, decorations for the festive season are becoming more sophisticated with moving reindeers and 3D mesh animals for front lawns. Of course, people want to be original with their decorating ideas and to have designs that are distinct for their neighbors.

It is therefore an object of the invention to provide a perforated mat that facilitates supporting of decorative lights in holes formed therein.

### SUMMARY OF THE INVENTION

In accordance with the invention there is provided a flexible mat comprising: a first side a perforated mat comprising: a first side and a second side approximately parallel to the first side; and, a plurality of perforations arranged in a grid pattern and traversing the flexible mat from the first side to the second side, wherein at least one of the perforations from the plurality of perforations is for frictionally supporting an ornamental light therein and where at least one of the perforations from the plurality of perforations is individually addressable.

In accordance with the invention there is provided a method comprising: providing a perforated mat comprising a first side and a second side and a plurality of perforations arranged in a grid pattern traversing the perforated mat from the first side to the second side; providing at least one of a design template and template instructions for addressing at least one of the perforations arranged in the grid pattern; inserting at least an ornamental light within at least one of the plurality of perforations formed within the perforated mat; and, frictionally supporting the at least an ornamental light within the at least one of the plurality of perforations.

### BRIEF DESCRIPTION OF THE DRAWINGS

Exemplary embodiments of the invention will now be described in conjunction with the following drawings, in which:

FIG. 1a illustrates a first embodiment of the invention, a perforated mat having a plurality of perforations, or holes, formed therein;

FIG. 1b illustrates a plurality of holes that traverse from a first side of the perforated mat to a second side, substantially parallel to the first side of the perforated mat;

FIGS. 1c and 1d illustrate how each of the plurality of holes are sized in order to accommodate a light, such as a decorative light;

FIGS. 2a and 2b illustrate sample patters that are formed by inserting lights into the plurality of perforations of the perforated mat;

FIG. 2c illustrates an example of template instructions;

FIGS. 3a and 3b illustrate different edge configurations as an attachment means for the perforated mats in order to facilitate joining together of adjacent perforated mats in order to create larger designs;

FIG. 4 illustrates an exemplary design template used for routing of lights on the perforated mat;

FIG. 5a illustrates a first part of joining clip in perspective view;

FIG. 5b illustrates a second part of the joining clip for frictionally engaging the first part of the joining clip;

FIGS. 5c and 5d illustrate the first and second parts of the joining clip frictionally engaged with one another and for facilitating attachment between adjacent perforated mats;

FIG. 6a illustrates an embodiment of a vertical support post for supporting of the perforated mat;

FIG. 6b illustrates a support footing for being optionally disposed at an end of the vertical support post for frictionally engaging the vertical support post for facilitating stability of the vertical support post;

FIG. 6c illustrates a front view of the vertical support post showing a cavity within the perforated mat engagement protrusion;

FIGS. 7a through 7c illustrate various views of a wall mount support for facilitating disposing of the perforated mat on a wall or other approximately vertical surface;

FIG. 8a illustrates a front view of the perforated mat being supported by the vertical support post having the support footing attached at an end thereof;

FIG. 8b illustrates a back view of the perforated mat being supported by the vertical support post having the support footing attached at an end thereof;

FIG. 8c illustrates a side view of the perforated mat being supported by the vertical support post;

FIG. 8d illustrates a bottom view of the vertical support post having a receptacle formed therein at an end thereof for receiving of an opposite end of another vertical support post; and,

FIG. 8e illustrates two vertical support posts stacked on top of one another for providing added height for supporting of the perforated mat in at least two different places along an approximately vertical axis.

### DETAILED DESCRIPTION OF EMBODIMENTS OF THE INVENTION

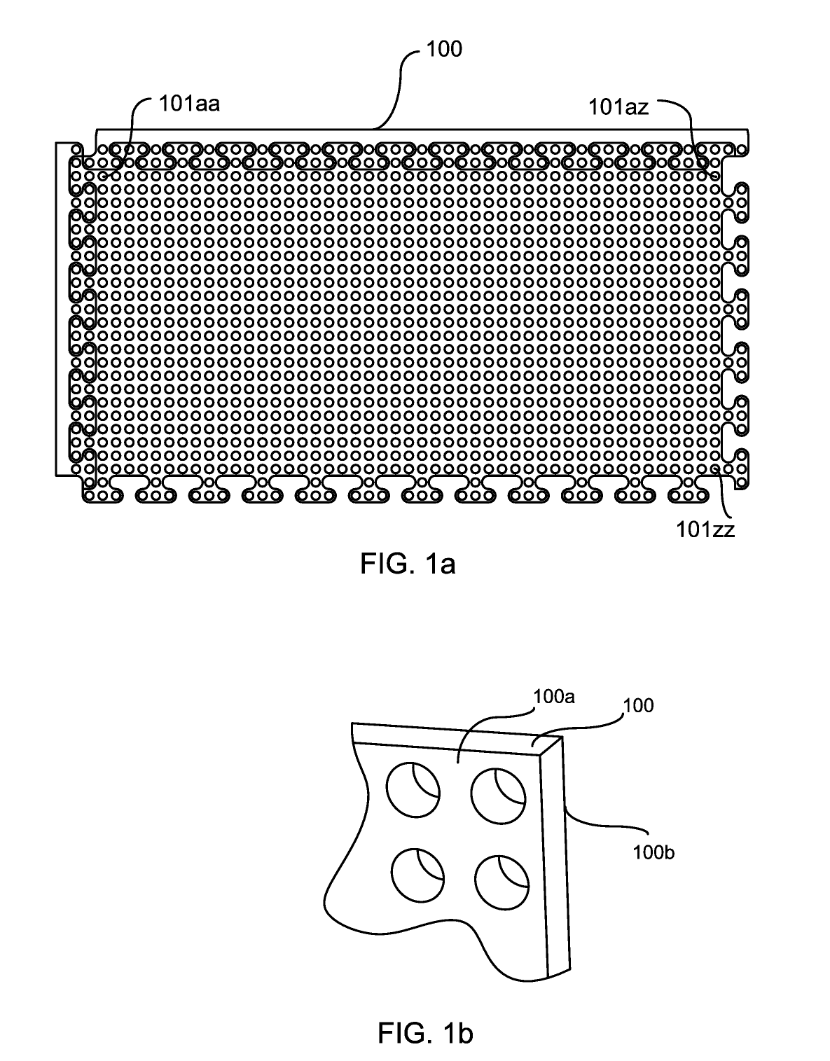

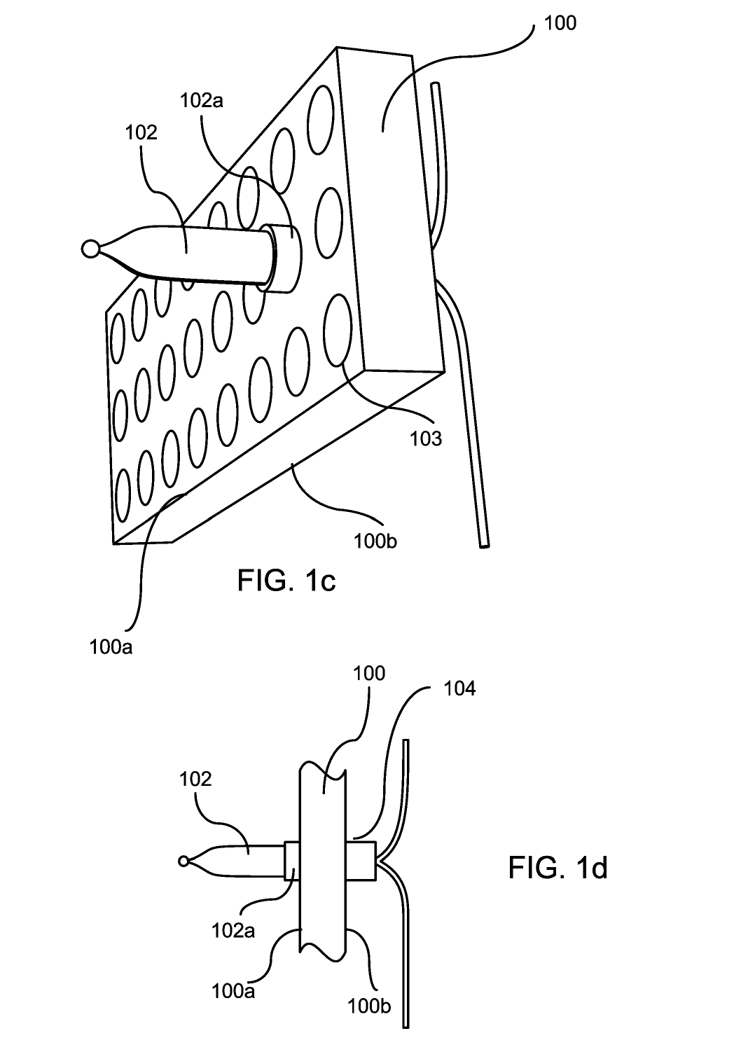

FIG. 1a illustrates a first embodiment of the invention, a perforated mat 100 having a plurality of perforations 101aa through 101zz, or holes, formed therein. Referring to FIG. 1b, each of the plurality of holes 101aa through 101zz traverse from a first side 100a of the perforated mat 100 to a second side 100b, substantially parallel to the first side 100a, of the perforated mat 100. Referring to FIGS. 1c and 1d, each of the plurality of holes 101aa through 101zz is sized in order to accommodate a light 102, such as for example an ornamental light such as a conventional Christmas light. Preferably, a perforation diameter 103 of the perforations are of a smaller perforations diameter 103 than an outer diameter 104 of a housing 102a of the light 102 so that the outer diameter of the light 104 is frictionally engaged by an inner diameter 103 of one of the plurality of perforations 101aa through 101zz. In this manner, at least a light 102 is frictionally supported within at least one of the perforations, 101aa through 101zz.

Preferably the perforated mat 100 manufactured from a foam type material such as that which is used for manufacturing of play mats for children. For example, the material for the perforated mat 100 is of a mid density foam for facilitating supporting of the at least a light 102 within the at least one of the perforations, 101aa through 101zz. Preferably the thickness of the perforate mat is approximately between a half of an inch and three quarters of an inch, which is preferably available in a variety of colors.

Preferably the plurality of perforations 101aa through 101zz are spaced apart at approximately same intervals, forming a grid like pattern. The grid like pattern is not necessarily arranged in orthogonal columns and rows but optionally deviates therefrom, for example, in the form of a diagonal grid pattern or a circular grid pattern. Of course, other grid patterns are also envisaged.

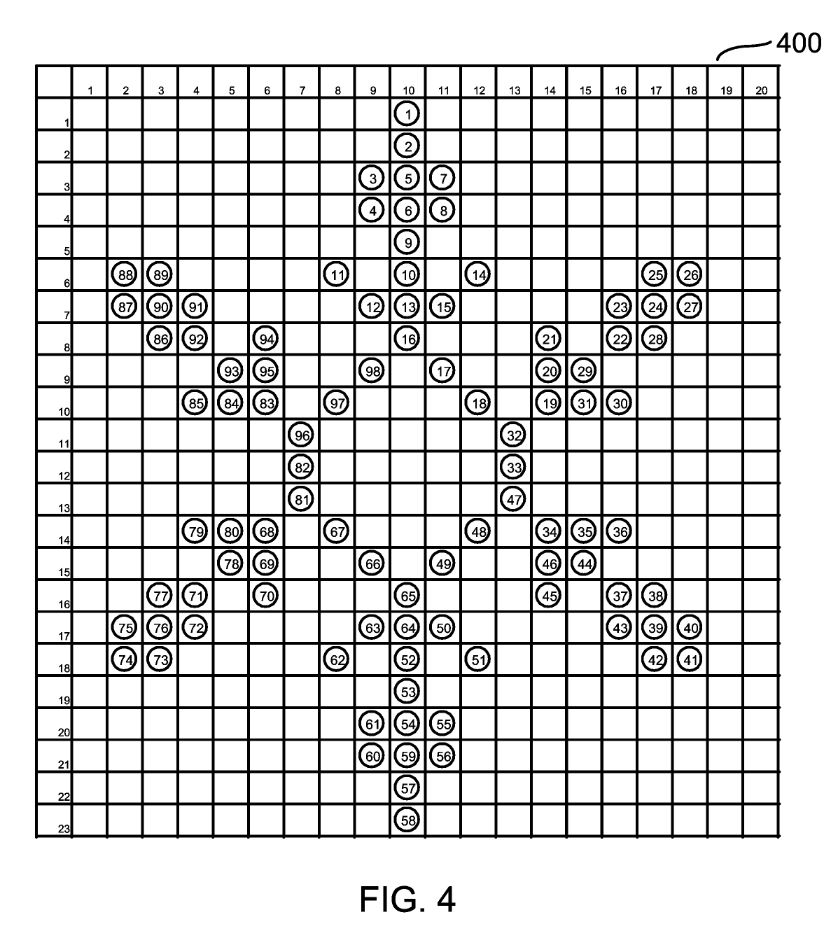

In use of the perforated mat 100, lights 102 are inserted into at least one of the plurality of perforations 101aa through 101zz from the second side 100b to protrude from the first side 100a in a predetermined manner that is either established using a design template 400 (FIG. 4) having a predetermined design, or by that of a creative person is inserting the lights into the perforated mat 100. Once inserted, these lights, when illuminated, produce an illuminated pattern in accordance with that which was created by the person when installing the lights into the perforated mat 100.

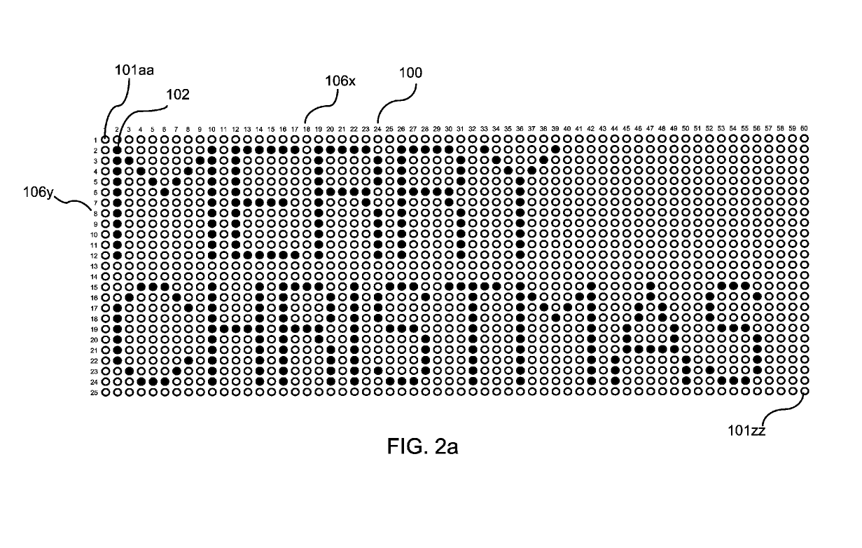

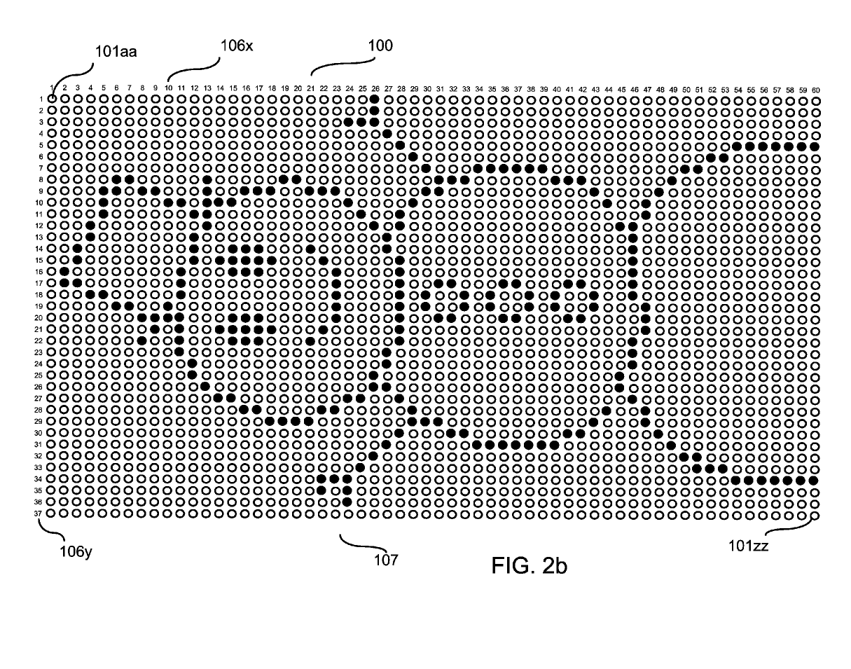

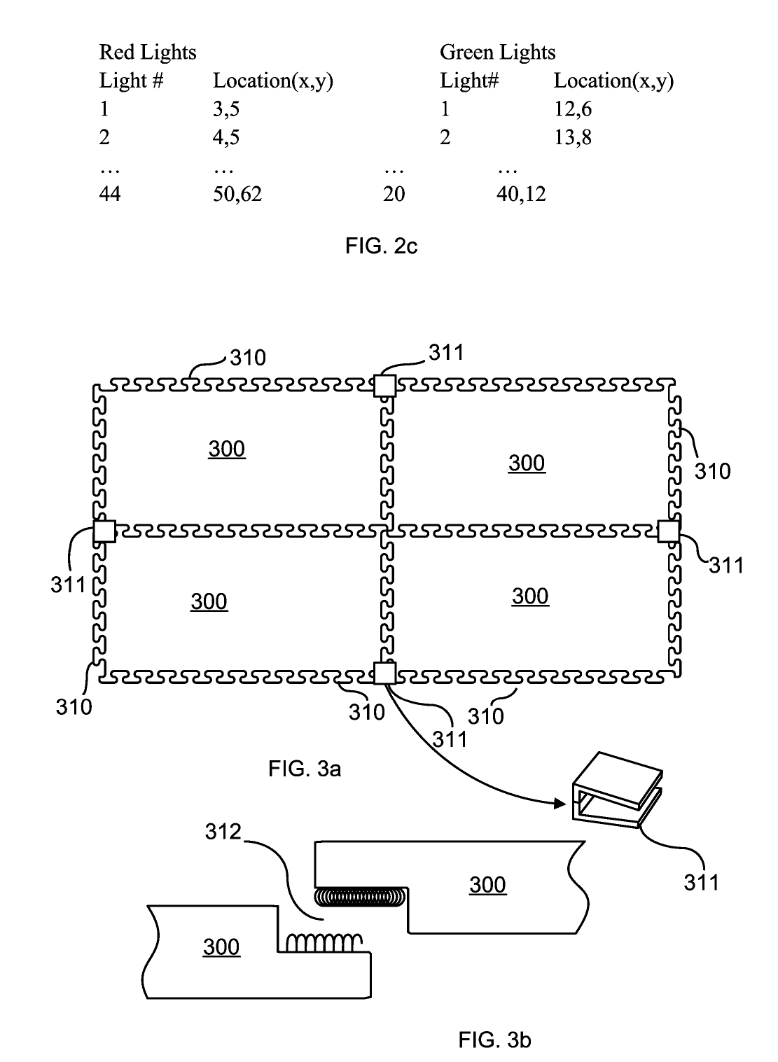

Referring to FIGS. 2a and 2b, these illustrate sample patters that are formed by inserting lights 102 into the plurality of perforations of the perforated mat 100. Only the first side 100a of the perforated mat is shown with the bulb portion of the light 102 extending from this side. A grid marking, preferably along a horizontal axis 106x and preferably along a vertical axis 106y, is preferably disposed on at least one of sides, 100a or 100b, of the perforated mat 100, for facilitating making illuminated designs with the aid of the design template 400 (FIG. 4). With the provision of the design template 400 (FIG. 4), the advantages of the first embodiments of the invention are realized since not every individual possesses creative talents. Thus, with the provision of the design template 400 (FIG. 4), the creation of aesthetically pleasing designs is facilitated. Optionally, the design template 400 (FIG. 4)s are provided via a website.

For example, the design template 400 (FIG. 4) is either a supplemental piece of paper, or pieces of paper that correspond to the grid markings, 106x and 106y, on the mat. In use, the template is held against the second side 100b of the mat to indicate where to insert the lights 102 into one of the perforations formed as part of the perforated mat 100. Markings on the design template 400 (FIG. 4) correspond to at least some of the plurality of perforations 101aa through 101zz on the perforated mat 100. The template is also envisaged as being a set of template instructions, which includes a light number and light location within the grid 106x and 106y. An example of template instructions is shown in a table of FIG. 2c.

With such a template, an individual inserts the lights 102 into the holes 101aa through 101zz according to the instructions and results in a pattern (such as those shown in FIGS. 2a and 2b) in accordance with the template instructions (FIG. 2c). Additionally, each template is preferably provided with a type and quantity of light that are to be used for making a design in accordance with the design template 400 (FIG. 4). If for example, to create the design for the template instructions shown in FIG. 2c, forty four (44) red lights are used and twenty (20) green lights are used, then the template instructions are indicative of such. Thus, the user is made aware prior to engaging on a design task as to the number of lights that are required for a given design instructions or the design template 400 (FIG. 4).

FIGS. 3a and 3b illustrate different edge configurations for the perforated mats 300 in order to facilitate joining together of adjacent perforated mats 300 along their edges. For example, FIG. 3a illustrates an attachment means 310 disposed about at least a portion of an outer periphery of at least two adjacent perforated mats 300 in order to facilitate joining of adjacent perforated mats the mats together along their outside edges. An optional clamp 311 is also provided in order to hold the mats together. FIG. 3b shows another attachment means 312 in the form of a hook and loop fastening mechanism such as Velcro™ disposed between adjacent edges of the mats 300 in order to facilitate attachment of one to the other. Of course, other attachment means for attaching of adjacent perforated mats 300 are also envisaged and are not the focus of this disclosure. Optionally, joining pins, manufactured from clear plastic, which blend with perforated mat 300 color, are used for joining of adjacent mats. In this manner, individual perforated mats 300 are connected together to create a bigger mat for extravagant designs.

FIG. 4 illustrates an exemplary design template 400 for use in routing of lights on the perforated mat 100. The routing of the lights is performed in sequence, starting from number one (1). Preferably, the ornamental light furthest from the plug is dispose in the perforation in the perforated mat 100 denoted by number one (1). In this manner, when all the lights on a first string are disposed in the holes, a second string is attached and the routing is continued until the desired pattern is completed.

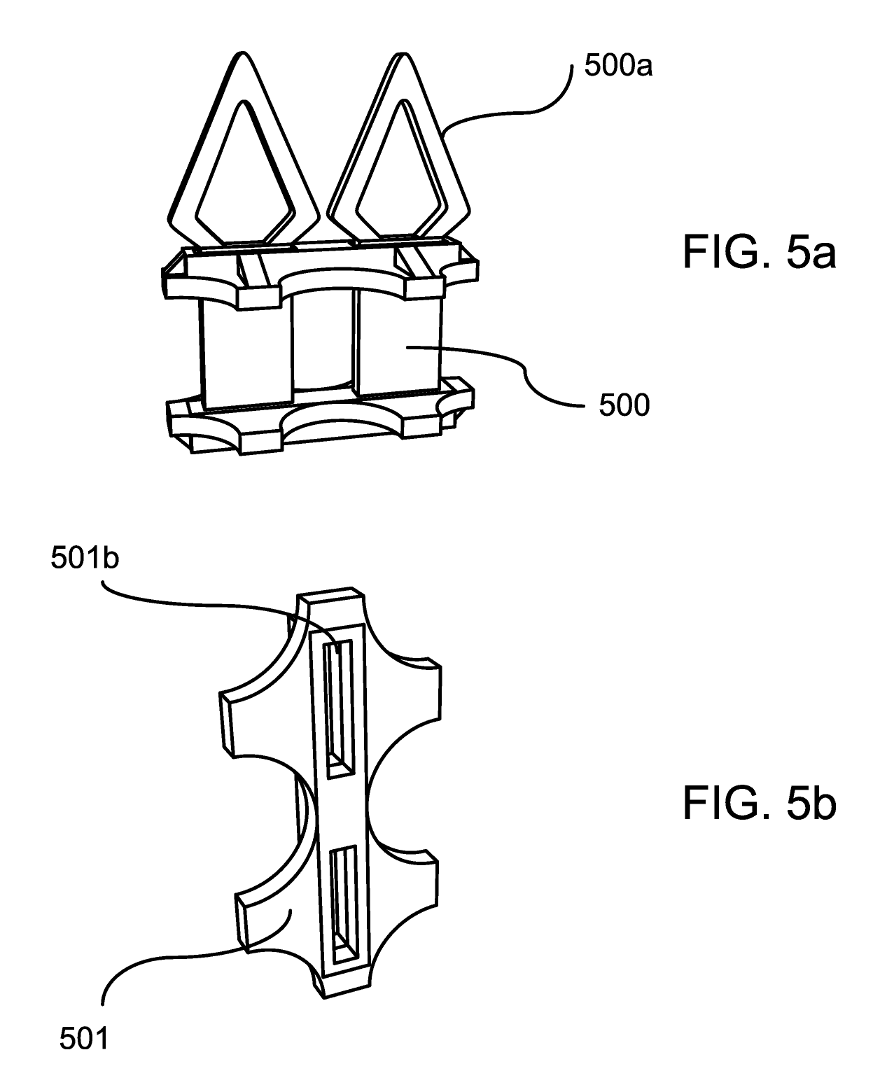

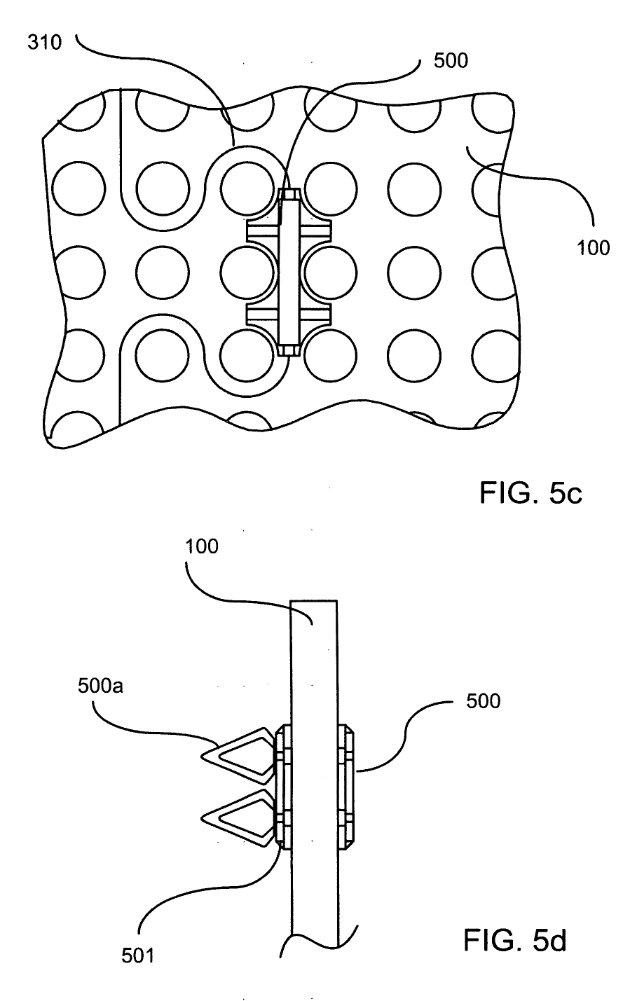

FIG. 5a illustrates a first part of joining clip 500 in perspective view and FIG. 5b illustrates a second part of the joining clip 501. The first and the second parts of the joining clip are made to frictionally engage one another for being used to join two adjacent perforated mats 100. For the frictional engagement, protrusions from the first part of joining clip 500 are made for frictionally engaging receptacles 501b formed within the second part of the joining clip 501. FIGS. 5c and 5d illustrate the first and second parts of the joining clip, 500 and 501, frictionally engaged with one another and for facilitating attachment between adjacent perforated mats 100 in proximity of the attachment means 310. FIG. 5c illustrates a front view and FIG. 5d illustrates a side view of the first part of joining clip 500 frictionally engaged with the second part of the joining clip 501, securing at least a portion of the attachment means 310 therebetween.

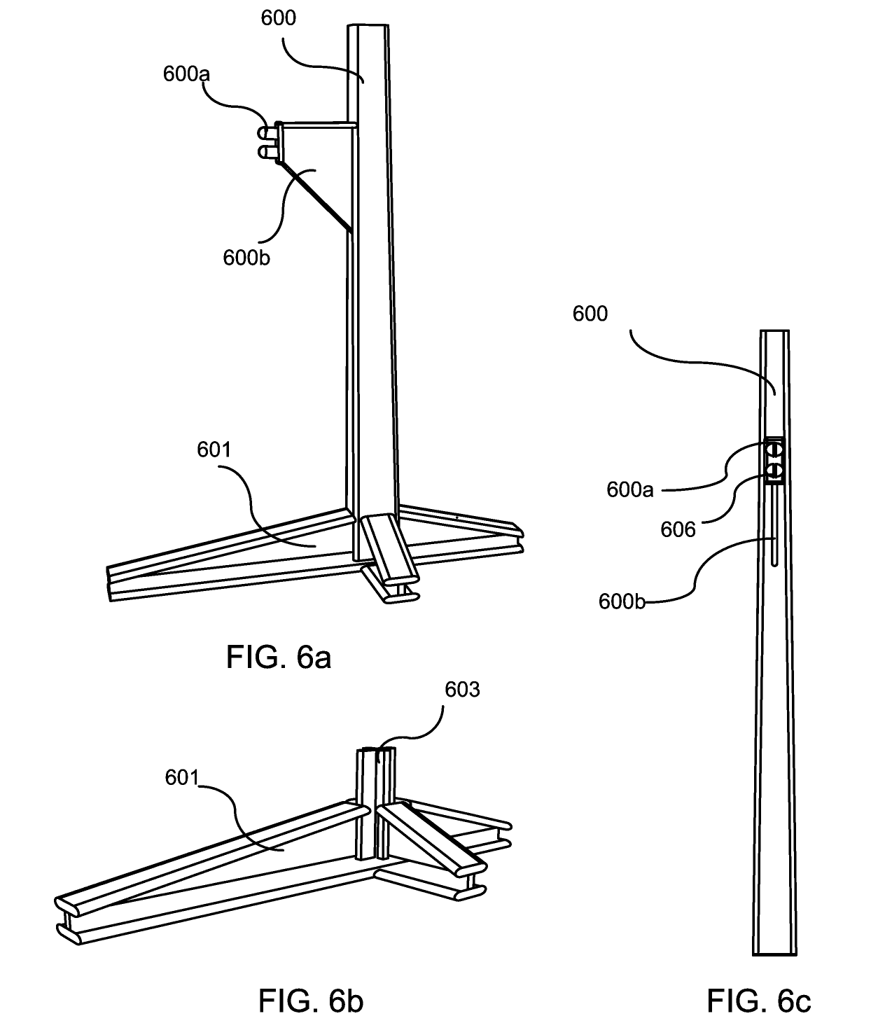

FIG. 6a illustrates an embodiment of a vertical support post 600 for supporting of the perforated mat 100. A perforated mat engagement protrusion 600a is provided for frictionally engaging at least one of the perforations in the perforated mat 100. Preferably the perforated mat engagement protrusion 600a facilitates insertion into at least one of the perforations in the perforated mat 100 and other than facilitates extraction therefrom. Optionally, a support post arm 600b is also provided for having the support post protrusion 600a disposed at an end thereof opposite the vertical support post 600. The support post arm 600b preferably provides a few inches of clearance from the vertical support post 600 or other surface for facilitating routing of the wiring. FIG. 6b illustrates a support footing 601 that is for being optionally disposed at an end of the vertical support post 600 for frictionally engaging the vertical support post 600 for facilitating stability of the vertical support post 600 when the vertical support post 600 is, for example, disposed on a ground surface. FIG. 6c illustrates a front view of the vertical support post 600, thus showing a cavity 606 within the perforated mat engagement protrusion 600a. This cavity 606 facilitates insertion of the perforated mat engagement protrusion 600a within at least one of the protrusions formed within the perforated mat 100 and other than facilitates extraction therefrom.

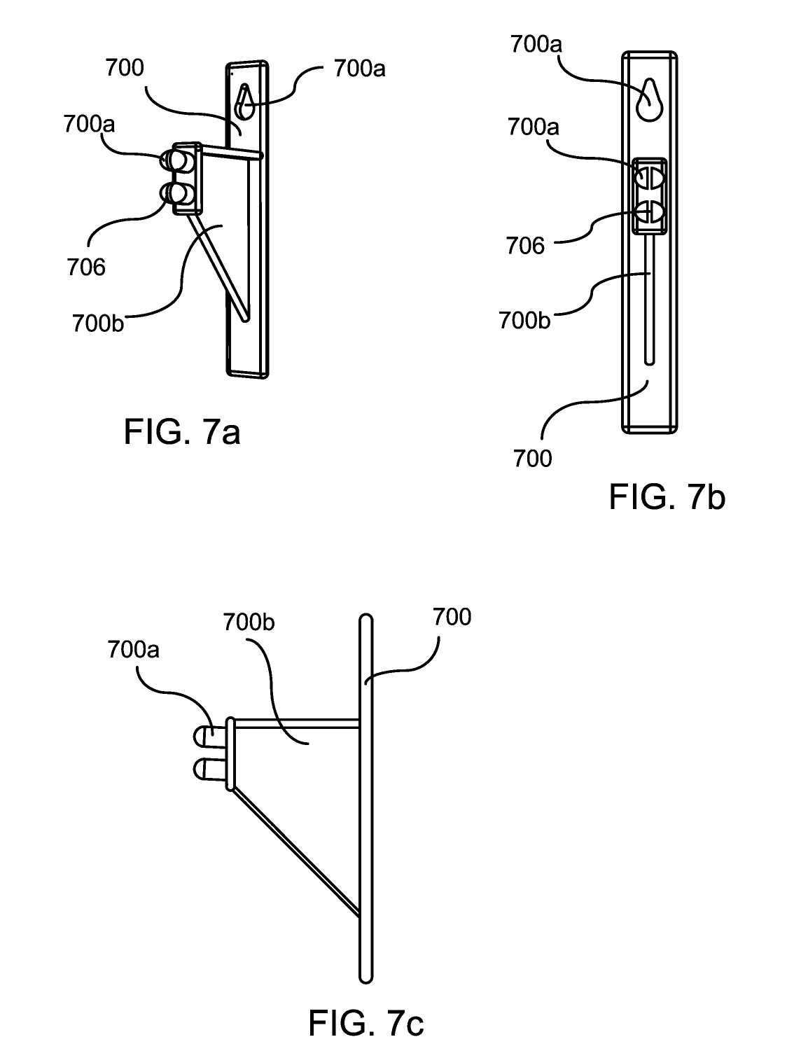

FIGS. 7a through 7c illustrate various views of a wall mount support 700 for facilitating disposing of the perforated mat 100 on a wall or other approximately vertical surface.

A perforated mat engagement protrusion 700a is provided for frictionally engaging at least one of the perforations in the perforated mat 100. Preferably the perforated mat engagement protrusion 700a facilitates insertion into at least one of the perforations in the perforated mat 100 and other than facilitates extraction therefrom. Optionally, a support post arm 700b is also provided for having the support post protrusion 700a disposed at an end thereof opposite the wall mount support 700. The support post arm 700b preferably provides a few inches of clearance from the wall mount support 700 or other surface for facilitating routing of the wiring. An aperture 700a is provided within the wall mount support 700 for facilitating mounting of the wall mount support 700 to an approximately vertical surface. FIG. 7c illustrates a front view of the wall mount support 700, thus showing a cavity 706 within the perforated mat engagement protrusion 700a. This cavity 706 facilitates insertion of the perforated mat engagement protrusion 700a within at least one of the protrusions formed within the perforated mat 100 and other than facilitates extraction therefrom.

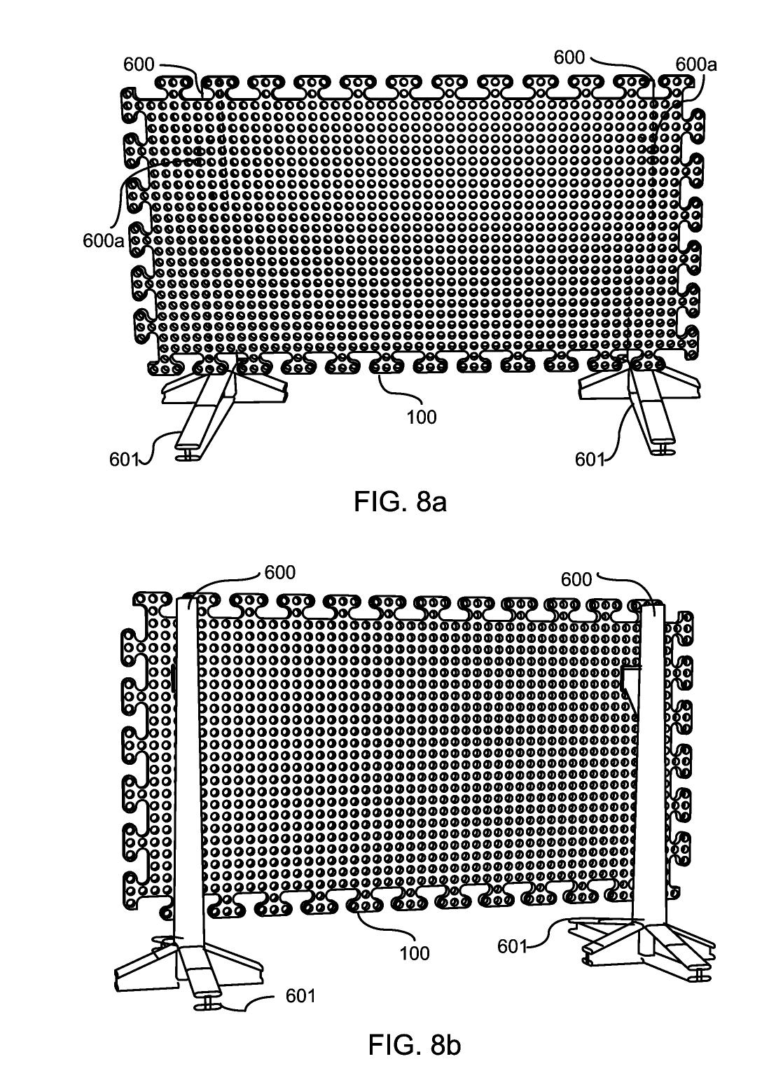

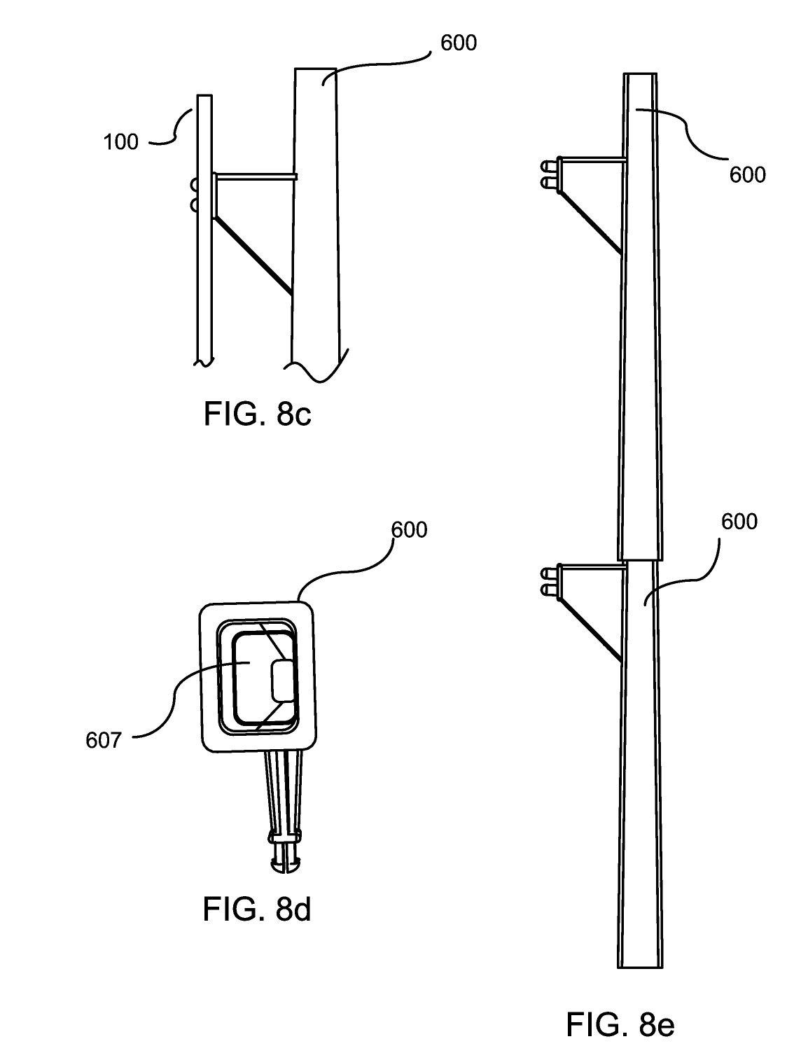

FIG. 8a illustrates a front view of the perforated mat 100 being supported by the vertical support post 600 having the support footing 601 attached at an end thereof. FIG. 8b illustrates a back view of the perforated mat 100 being supported by the vertical support post 600 having the support footing 601 attached at an end thereof. FIG. 8c illustrates a side view of the perforated mat 100 being supported by the vertical support post 600. FIG. 8d illustrates a bottom view of the vertical support post 600 having a receptacle 607 formed therein at an end thereof for receiving of an opposite end of another vertical support post 600. Referring to FIG. 8e, two vertical support posts 600 are shown stacked on top of one another for providing added height for supporting of the perforated mat 100 in at two places along an approximately vertical axis.

Another embodiment of the invention is a computer program in order to facilitate providing of different template instructions for facilitating the creation of various different designs. The computer program has stored therein a plurality of different design templates and the user views these templates on the computer monitor. When the user selects a design of interest, the computer program generates a set of template instructions for creating of such a design. Preferably, the template instructions provided by the computer program are such that the routing of the lights is in such an order to utilize the fewest number of lights and to minimize the connection lengths therebetween. Additionally, the program determines a number of lights required and the colors thereof. In this manner, the user is made aware of all the light requirements before undertaking the design task. Optionally, the computer program is also provided with a custom design section, where a used creates their design on screen and the computer program generates the template instructions for routing of the lights.

In a variation of the second embodiment of the invention the computer program is WWW based, where the user performs their selection of design templates 400 or custom creation of their own templates using the web site. Optionally, after the user has selected a design or has created their own design, a link on the website directs the user to another site where the user orders the lights. Preferably, the light order is pre filled with the light requirements for the currently selected design and the user approves this light order and the lights are shipped to the user. Optionally the perforated mat or mats, are made available to the user with the lights.

Optionally, the perforated mat is provided with perforations having plugs that are not completely punched through and remain in the holes, either frictionally engaged therein, or lightly held by remaining pieces of the mat material the were not completely removed during a hole punching process. In this manner, only those lights inserted into the holes remove the plugs, and where lights are not inserted the plugs remain. This advantageously hides that which is behind the mat, adjacent the second side, and prevents some of the lights that are not in the holes to not shine through in undesired locations.

Provisions for attaching the mat to posts are also envisaged so that the mat is optionally disposed in a standalone manner on the ground, such as for example a lawn.

Advantageously, once the design is completed on the perforated mat, because of the flexibility of the mat, it facilitates rolling up thereof for improved storage. Preferably the perforated mat is rolled in such a manner that the ends of the lights are protected on the inside of the roll and the backs of the lights, along with the wires, are on an outside of the roll.

Advantageously, the perforated mat is useable for any number of different holidays, such as for Halloween to make pumpkins patterns and other patterns. It is also optionally used for Birthdays, Weddings, etc. Although Christmas is the biggest season it could be used and sold year round. Furthermore, the mat when sold preferably includes a few design templates 400 or template instructions (FIG. 2c) in the package to aid in getting the user started. Because of a follow the dots concept, an optimal path is used for stringing of lights and thus the mat is suitable for many age groups.

In a further advantage of the embodiments of the invention, the perforated mat as a product allows the user to create aesthetically pleasing light patterns every year without having to purchase a whole new set of ornaments. For light vendors, it promotes the purchase of new lights.

Numerous other embodiments may be envisaged without departing from the spirit or scope of the invention.

1. A perforated mat comprising:
a first side and a second side approximately parallel to the first side; and,
a plurality of perforations arranged in a grid pattern and traversing the flexible mat from the first side to the second side, wherein at least one of the perforations from the plurality of perforations is for frictionally supporting an ornamental light therein and where at least one of the perforations from the plurality of perforations is individually addressable.

2. A perforated mat according to claim 1 wherein the plurality of perforations are arranged in columns and rows and at least one of the perforations from the plurality of perforations is individually addressable using a column indicator and a row indicator.

3. A perforated mat according to claim 2 wherein the column indicator and the row indicator are printed on at least one of the first side and the second side of the flexible mat.

4. A perforated mat according to claim 1 comprising attachment means disposed about at least a portion of an outer periphery of the perforated mat in order to facilitate coupling of adjacent perforated mats together along their outside edges.

5. A perforated mat according to claim 4 wherein the attachment means comprises at least a clamp mechanism for being disposed between the first side and the second side of two adjacent perforated mats for facilitating coupling together of adjacent perforated mats.

6. A perforated mat according to claim 4 wherein the attachment means comprises a joining clip comprising a first part and a second part, wherein the first part of the joining clip comprises protrusions for penetrating from the first side to the second side of two adjacent perforated mats, where protrusions from the first part of joining clip are for frictionally engaging receptacles formed within the second part of the joining clip.

7. A perforated mat according to claim 4 wherein the attachment means comprises a hook and loop fastening mechanism.

8. A perforated mat according to claim 1 comprising a support post comprising:
an engagement protrusion for frictionally engaging at least one of the perforations in the perforated mat; and,
a support footing for being disposed at an end of the vertical support post for providing stability of the support post.

9. A perforated mat according to claim 1 comprising a wall mount support comprising:
an engagement protrusion for frictionally engaging at least one of the perforations in the perforated mat; and,
an aperture for facilitating disposing of the perforated mat on an approximately vertical surface.

10. A perforated mat according to claim 9 comprising a cavity formed within the engagement protrusion for at least one of facilitating inserting of the engagement protrusion into at least one of the perforations in the flexible mat and other than facilitating withdrawing of the engagement protrusion therefrom.

11. A perforated mat according to claim 1 wherein the mat is made from a foam type material.

12. A perforated mat according to claim 1 wherein the mat is made from a flexible material.

13. A perforated mat according to claim 1 wherein an inner diameter of at least one of the perforations is of a smaller diameter than an outer diameter of housing of the ornamental light.

14. A method comprising:
providing a perforated mat comprising a first side and a second side and a plurality of perforations arranged in a grid pattern traversing the perforated mat from the first side to the second side;
providing at least one of a design template and template instructions for addressing at least one of the perforations arranged in the grid pattern;
inserting at least an ornamental light within at least one of the plurality of perforations formed within the perforated mat; and,
frictionally supporting the at least an ornamental light within the at least one of the plurality of perforations.

15. A method according to claim 14 comprising addressing at least one of the plurality of perforations formed within the perforated mat using the template instructions that comprise a list of columns and rows.

16. A method according to claim 14 comprising providing of at least one of the template instructions and the design template from an online source.
